(19) United States
(12) Patent Application Publication
(10) Pub. No.: US 2011/0105034 A1
(43) Pub. Date: May 5, 2011

(54) Active voice cancellation system

(76) Inventors: John W. Senders, Toronto (CA); James Shen, Toronto (CA)

(21) Appl. No.: 12/588,950

(22) Filed: Nov. 3, 2009

(51) Int. Cl. H04B 15/00; G10K 11/16

(52) U.S. Cl. 455/63.1; 381/71.1

(57) ABSTRACT

The present invention relates to a speech cancellation system for actively reducing the audibility to nearby persons of the voice of the user into a personal communication device. This active noise cancellation system is comprised of a primary sound detection element to transform the original speech signal into electrical form and to transform the electrical speech signal into an electrical form from which the original sound could be reproduced and to organize it into digital sequences; a digital memory to store the digitized speech signal; a digital processor to change the polarity of the digital speech signal into its inverse; a further digital processor to insert a variable time delay between the inverted digital signal and the original digital signal; a digital to analog converter transform the inverted and delayed signal into analog form; a variable attenuator to alter the intensity of the inverted and delayed signal; a means to convert the inverted, delayed and attenuated signal into sound waves, such as a secondary electro-acoustic transducer; and a secondary acoustic-to-electric transducer to convert the attenuated delayed inverted signal plus the original speech signal into electrical form. The signal from the secondary acoustic-to-electric transducer is fed back to the attenuator and the delay devices in such a way that they are both independently altered by negative feedback so as to reduce the signal strength and altering the time delay so as to reduce the sound level of the sound field immediately surrounding the user of the personal communication device.

### FIELD OF INVENTION

The present invention relates to voice cancellation systems, and is directed particularly, but not solely, towards a voice cancellation system for personal communication devices.

### BACKGROUND OF THE INVENTION

The purpose of the noise cancellation technology is to minimize or eliminate unwanted sounds. Noise canceling technologies consist in detecting the sounds in a given environment. Processing and determining what sound wave is required to cancel the unwanted noise. Then it creates that sound and amplifies it through electro-acoustic transducers such as loudspeakers thereby reducing or eliminating the unwanted sounds.

One important application of this technology can be found in mobile telecommunications. With the explosive growth of wireless communications there is a concern with privacy due to people in close proximity listening to conversations in telecommunication devices such as wireless devices. On the other hand, the conversation of others in public places can be a nuisance for individuals near the user's location. This unwanted noise source can be minimized by an active voice cancellation system such as the one described in this invention.

### PRIOR ART

A voice cancellation system has been disclosed by Berger and Jones in U.S. Pat. No. 5,526,421. In this system the voice transmission of a person is cancelled by introducing a mirror-image wave form with respect to the signal generated when speaking into the microphone. One of the problems with this design is that the noise cancellation may not be complete generating residual noise and leading to improper cancellation.

Wittke, et al. proposed a voice cancellation system for phone privacy and unobtrusiveness that addressed the above problems in U.S. Pat. No. 6,952,474, by having multiple speakers spherically disposed about the voice input microphone and far-field sensors spherically arranged about the speakers to detect how well the speakers reduce the voice transmission. The problem with this design is not integrated with the communication device and the complexity due to the numerous speakers and far-field sensors located far, four inches, from the primary microphone.

### SUMMARY OF THE INVENTION

Accordingly, it is the purpose of the present invention to improve on the previous designs by introducing a secondary electro-acoustic transducer integrated with an acoustic-to-electric transducer (i.e. speaker-microphone) for actively reducing the audibility to nearby people of the voice of a user into a personal electronic communication device such as a cell phone; and to reduce the level of nuisance/irritation of nearby casual hearers of such conversations.

According to one aspect of this invention the system includes:

detecting means, such as a microphone, for detecting the noise emitted by a noise source, such as a person's voice speaking into a cellular phone, and producing noise signals in response thereto;
storage means for storing a plurality of noise signals to generate transformation sounds which, when combined with the noise emitted by said noise source, produce replacement sounds in which said emitted noise is replaced, reduced or eliminated;
processor means communicative with said detecting means and said storage means, said processor means receiving said noise signals from said detecting means and dynamically monitoring said noise signals, said processor means further selecting and receiving transformation sound signals from said storage means in response to said noise signals such that the combination of said noise and the transformation sounds generated by said selected transformation sound signals produces replacement sounds in which said emitted noise is replaced, reduced or eliminated; and
electro-acoustic transducer means such as a loud speaker for emitting said transformation sounds to combine said sounds with said noise, said electro-acoustic transducer means being communicative with said processor means, such that said processor means controls said secondary electro-acoustic transducer means to cause said transformation sounds to be emitted and combined with said noise;
secondary detecting means integrated with said secondary electro-acoustic transducer means for monitoring said replacement sounds, said secondary detection means communicative with said processor means, such that said processor means dynamically adjust said replacement sounds in which said emitted noise is replaced, reduced or eliminated.

According to another aspect of this invention the said processor means may include radio frequency (RF) transmitter, and wherein said secondary loudspeaker means further includes an RF receiver, such that said processor means communicates with said loudspeaker means through said RF transmitter and RF receiver.

According to another aspect of this invention the said processor means communicative with said detecting means and said storage means, said processor means receiving said noise signals from said detecting means and dynamically monitoring said noise signals, said processor means further selecting and receiving transformation sound signals from said storage means in response to said noise signals such that the combination of said noise and the transformation sounds generated by said selected transformation sound signals produces replacement sounds in which said effects are alleviated; wherein said processor means selects said primary transformation sound substantially continuously, and wherein said processor means modulates the amplitude of said transformation sounds emitted by said speakers with a filtered signal derived from said noise signals.

According to another aspect of this invention the said processor selects a first secondary transformation sound for time periods wherein the amplitude of said noise substantially exceeds the amplitude of said primary transformation sound.

According to another aspect of this invention wherein said processor selects a second secondary transformation sound for time periods wherein the amplitude of said primary transformation sound is decreasing.

According to another aspect of this invention wherein said processor means filters and dynamically tracks said noise signals to produce a first tracking signal with a short response time and a second tracking signal with a long response time, and wherein said processor means selects said first secondary transformation sound by comparing said first tracking signal and said second tracking signal.

According to another aspect of this invention wherein said filtered signal comprises said second tracking signal.

According to another aspect of this invention the electro-acoustic transducer means for emitting said transformation sounds to combine said sounds with said noise, said electro-acoustic transducer means being communicative with said processor means, such that said processor means controls said electro-acoustic transducer means to cause said transformation sounds to be emitted and combined with said noise; wherein said noise source comprises a freeway having vehicular traffic which emits said noise, and wherein said transformation sounds comprise the sound of ocean surf.

According to another aspect of this invention there is the possibility to do a Fourier Analysis (FA) and operate on the sinusoidal components of the FA to obtain the proper delay and power of the inversion. There are also possibilities of dealing with the bandwidth of the voice signal.

A method for suppressing the undesirable effects of noise emitted by a noise source by transforming the noise into replacement sounds in which said effects are alleviated, said method comprising the steps of:

detecting the noise to form a noise signal;
selecting a transformation sound in response to said noise signal which, when combined with said noise produces a replacement sound in which said undesirable effects are alleviated; and
combining said transformation sound with said noise to produce said replacement sound; wherein the step of selecting a transformation sound further comprises the steps of:
selecting a first transformation sound having a spectrum that envelops the spectrum of said noise;
combining said first transformation sound substantially continuously with said noise;
dynamically monitoring said noise signal to detect sudden increases in the volume of said noise;
selecting a second transformation sound; and
combining said second transformation sound with said noise and said first transformation sound during periods of said sudden increases in said noise volume.

According to another aspect of this invention further comprising the steps of:

selecting a third transformation sound; and
combining said third transformation sound with said noise and said first and second transformation sounds during periods when said first transformation sound is decreasing in volume.

According to another aspect of this invention there the possibility is to convert to a digital signal and operate on the digital signal before reconverting to analog sound waves.

According to another aspect of this invention wherein the noise suppression system could be programmed to permit the hearing of special signals from police, fire, and ambulance. The latter would incorporate ultrasonic signals to open the suppression to the voice signals.

### BRIEF DESCRIPTION OF THE DRAWINGS

The system for sound cancellation according to the present invention will now be described by way of example only, reference being to the accompanying drawings in which:

FIG. 1 illustrates a schematic diagram of the system incorporating the invention.

FIG. 2 is a diagram showing possible configurations of the secondary electro-acoustic transducer integrated with an acoustic-to-electric transducer (i.e. speaker-microphone)

FIG. 3 is a diagram showing an electronic communication device with the voice input, cancellation electro-acoustic transducer, secondary detection means in relation to the user and the electronic communication device.

### DETAILED DESCRIPTION OF THE INVENTION

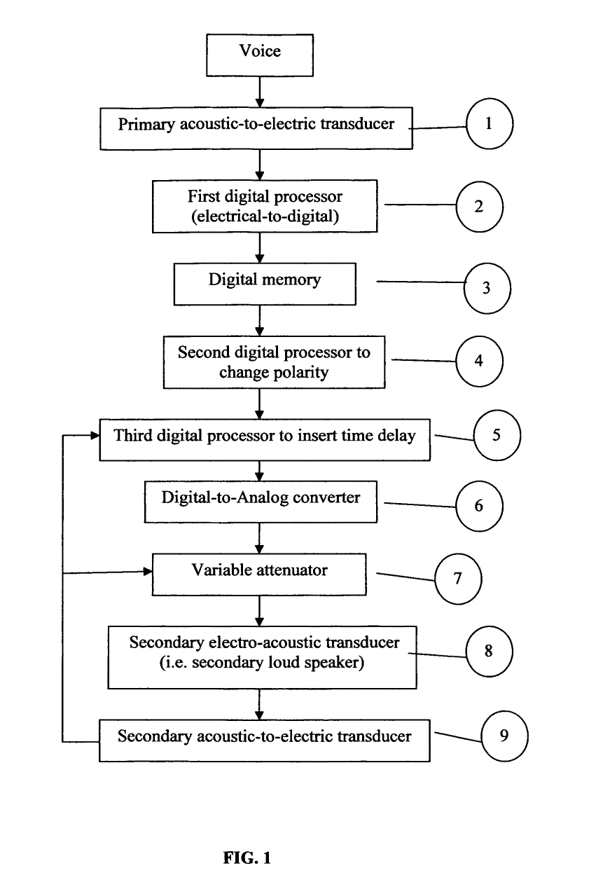

The present invention provides a system based on active sound cancellation techniques that use continuous feedback, simultaneously change amplitude and delay of inverted signal to minimize total signal. FIG. 1 shows an embodiment of the system for a speech cancellation system for actively reducing the audibility to nearby persons of the voice of a user into a personal communication device such as a cell-phone; and to reduce the level of nuisance/irritation of nearby casual hearers of such conversations. This active noise cancellation system is comprised of a primary sound detection element to transform the original speech signal into electrical form (1), such as a microphone; a first digital processor (2) to transform the electrical speech signal into an electrical form from which the original sound could be reproduced and to organize it into digital sequences; a digital memory (3) to store the digitized speech signal; a second digital processor (4) to change the polarity of the digital speech signal into its inverse; a third digital processor (5) to insert a variable time delay between the inverted digital signal and the original digital signal; a digital to analog converter (6) transforms the inverted and delayed signal into analog form; a variable attenuator (7) to alter the intensity of the inverted and delayed signal; a means to convert the inverted, delayed and attenuated signal into sound waves, such as a loudspeaker (8); and a secondary sound detection means such as a microphone (9) integrated to a secondary loudspeaker (8) to convert the attenuated delayed inverted signal plus the original speech signal into electrical form. The signal from the secondary sound detection means (9) is fed back to the attenuator and the delay devices in such a way that they are both independently altered by negative feedback so as to reduce the signal strength and altering the time delay so as to reduce the sound level of the sound field immediately surrounding the user of the cellular telephone.

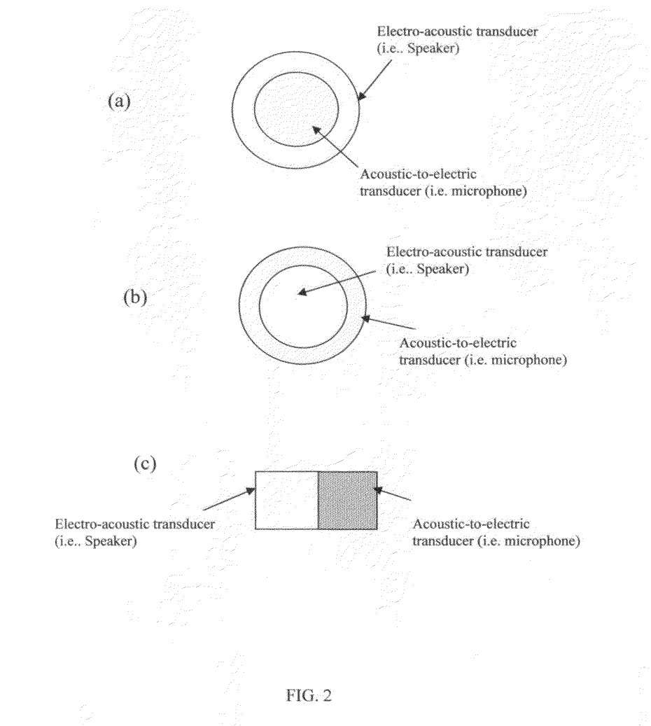

FIG. 2 shows possible configurations of the integrated speaker-secondary detection means where the secondary loud speaker and secondary microphone are concentric with said secondary microphone being in the center (a); wherein said integrated speaker-secondary detection means with the secondary loud speaker being in the center (b); and wherein the secondary microphone and speaker are next to each other.

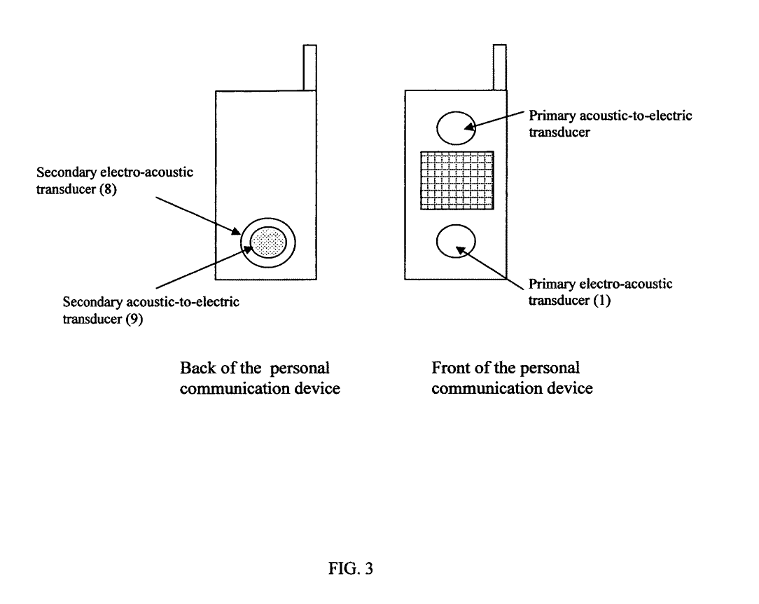

FIG. 3 shows a personal communication device such as a cell phone with the voice input, cancellation electro-acoustic transducer, secondary detection means in relation to the user and the personal communication device. The secondary acoustic-to-electric transducer (i.e. microphone) and electro-acoustic (i.e. speaker) are shown at the lower back of the personal communication device but could be located in any other location of the device. While this system and its application has been described and illustrated with respect to a one particular embodiment, it will be appreciated that numerous embodiments of the instrument may be made without departing from the scope of this invention.

Therefore what is claimed is:

1. A system for suppressing the undesirable effects of a noise source by transforming the noise emitted by the source into replacement sounds in which said effects are alleviated, said system comprising:
primary detecting means for detecting the noise emitted by said noise source and producing noise signals in response thereto;
storage means for storing a plurality of signals to generate transformation sounds which, when combined with the noise emitted by said noise source, produce replacement sounds in which said effects are alleviated;
processor means communicative with said primary detecting means and said storage means, said processor means receiving said noise signals from said detecting means and dynamically monitoring said noise signals, said processor means further selecting and receiving transformation sound signals from said storage means in response to said noise signals such that the combination of said noise and the transformation sounds generated by said selected transformation sound signals produces replacement sounds in which said effects are alleviated; and
secondary electro-acoustic transducer means for emitting said transformation sounds to combine said sounds with said noise, said secondary electro-acoustic transducer means being communicative with said processor means, such that said processor means controls said secondary electro-acoustic transducer means to cause said transformation sounds to be emitted and combined with said noise;
secondary detecting means integrated with said secondary electro-acoustic transducer means for monitoring said replacement sounds, said secondary detection means communicative with said processor means, such that said processor means dynamically adjust said replacement sounds in which said effects are alleviated.

2. The system according to claim 1, wherein said primary detecting means comprises an acoustic-to-electric transducer means.

3. The system according to claim 1, wherein the storage means is any of a solid state storage device (SSD), Compact Disk Read-only Memory (CD-ROM) and player, Read-Only Memory (ROM), or hard disk (HD).

4. The system according to claim 1, wherein said processor means includes an radio frequency (RF) transmitter, and wherein said electro-acoustic transducer means further includes an RF receiver, such that said processor means communicates with said electro-acoustic transducer means through said RF transmitter and RF receiver.

5. The system according to claim 1, wherein said storage means for storing a plurality of signals to generate transformation sounds which, when combined with the noise emitted by said noise source, produce replacement sounds in which said effects are alleviated, wherein said transformation sounds comprise a primary transformation sound and a plurality of secondary transformation sounds, said primary transformation sound having a spectrum that envelops the spectrum of said noise.

6. The system according to claim 1, wherein said processor means communicative with said detecting means and said storage means, said processor means receiving said noise signals from said detecting means and dynamically monitoring said noise signals, said processor means further selecting and receiving transformation sound signals from said storage means in response to said noise signals such that the combination of said noise and the transformation sounds generated by said selected transformation sound signals produces replacement sounds in which said effects are alleviated; wherein said processor means selects said primary transformation sound substantially continuously, and wherein said processor means modulates the amplitude of said transformation sounds emitted by said electro-acoustic transducer with a filtered signal derived from said noise signals.

7. The system according to claim 1, wherein said processor selects a first secondary transformation sound for time periods wherein the amplitude of said noise substantially exceeds the amplitude of said primary transformation sound.

8. The system according to claim 1, wherein said processor selects a second secondary transformation sound for time periods wherein the amplitude of said primary transformation sound is decreasing.

9. The system according to claim 1, wherein said processor selects a secondary transformation sound for time periods wherein the amplitude of said primary transformation sound is decreasing.

10. The system according to claim 1, wherein said processor means filters and dynamically tracks said noise signals to produce a first tracking signal with a short response time and a second tracking signal with a long response time, and wherein said processor means selects said first secondary transformation sound by comparing said first tracking signal and said second tracking signal.

11. The system according to claim 1, wherein said filtered signal comprises said second tracking signal.

12. The system according to claim 1, wherein said electro-acoustic transducer means being communicative with said processor means, such that said processor means controls said electro-acoustic transducer means to cause said transformation sounds to be emitted and combined with said noise; wherein said transformation sounds comprise replacement sounds.

13. The system according to claim 1, wherein said electro-acoustic transducer means and said secondary detection means are next to each other, such that said secondary detection means is concentrically surrounded by the secondary electro-acoustic transducer.

14. The system according to claim 1, wherein said electro-acoustic transducer means and said secondary detection means are next to each other, such that said secondary electro-acoustic transducer is concentrically surrounded by the secondary detection means.

15. The system according to claim 1, wherein said secondary detection means and said electro-acoustic transducer means are next to each other in a sequential manner along the axis of the electro-acoustic transducer.

16. A method for suppressing the undesirable effects of noise emitted by a noise source by transforming the noise into replacement sounds in which said effects are alleviated, said method comprising the steps of:
detecting the noise emitted by said noise source and producing noise signals in response thereto;
selecting a transformation sound in response to said noise signal which, when combined with emitted said noise produces a replacement sound in which said undesirable effects are alleviated; and
combining said transformation sound with said noise to produce said replacement sound; wherein the step of selecting a transformation sound further comprises the steps of:
selecting a first transformation sound having a spectrum that envelops the spectrum of said noise;
combining said first transformation sound substantially continuously with said noise;
dynamically monitoring said noise signal to detect sudden increases in the volume of said noise;
selecting a second transformation sound; and
combining said second transformation sound with said noise and said first transformation sound during periods of said sudden increases in said noise volume.

17. The method according to claim 16, further comprising the steps of:
selecting a third transformation sound; and
combining said third transformation sound with said noise and said first and second transformation sounds during periods when said first transformation sound is decreasing in volume.
